(19) United States
(12) Patent Application Publication
(10) Pub. No.: US 2010/0153214 A1
(43) Pub. Date: Jun. 17, 2010

(54) Accessing Needs of Customers Based on Dispatched Services

(75) Inventors: James Fan, San Ramon, CA (US); Vimal Begwani, Holmdel, NJ (US); Richard Kuo, Mountain View, CA (US); Waliur Rahman, Cedar Park, TX (US); Richard Stanze, Manchester, MO (US)

Correspondence Address: AT & T Legal Department - WS;Attn: Patent Docketing, Room 2A-207, One AT & T Way, Bedminster, NJ, 07921, US

(73) Assignee: AT&T INTELLECTUAL PROPERTY I, L.P., Reno, NV (US)

(21) Appl. No.: 12/333,752

(22) Filed: Dec. 12, 2008

(51) Int. Cl. G06Q 30/00; G06Q 10/00

(52) U.S. Cl. 705/14.55; 705/10

(57) ABSTRACT

Embodiments of the disclosed technology comprise a dispatch management system and method. Customer information is received by a first company and forwarded with dispatch instructions to a second company, namely, a dispatch company which handles dispatching a service technician or other support representative to the customer. The dispatch company then sends to the first company customer information regarding products and/or service related to the customer. It is then determined which products and/or services are to be advertised to the customer based on the customer information and information received from the dispatch company. Advertisements are then sent to the customer based on this determination.

### FIELD

The present disclosed technology relates generally to customer servicing, and more particularly, to selling services to customers based on the servicing.

### BACKGROUND

Monthly or yearly warranty and service plans are provided for a vast array of consumer goods and services. In the goods sector, appliances, electronics, alarm systems, and the like often have such plans available for purchase. In the services sector, phone lines, Internet connections, cable television, gas, electric, and other services frequently have such plans available for purchase. Alternatively, such plans are often paid for as month-to-month services to customers and may require servicing from time-to-time. Even without such plans, the company which manufactured or sold the goods or services is often called upon to provide servicing for its product.

Service technicians are usually sent to take care of problems that the customer may be having. Generally speaking, a customer may call a support hotline for a company that sold the product and service, and speak with a representative of the company who may try and solve the problem over the phone. If the problem can't be resolved, then a technician is dispatched. In many cases, the technician is either a contract laborer or actually hired by another company. Technicians dispatched may even think poorly of the company on whose behalf they are doing work and air their opinion to the customer, potentially damaging the reputation of the company with no recourse by the company. Still further, when a technician is dispatched to the home or office of a customer, this is an opportune time to assess the needs of the customer. Ample face time with the customer and a close understanding of the customer's needs may be garnered during this time.

Current methods known in the art are, for example, to inform all customers of a new service or a service which the customer does not already have by sending blanket advertisements. A cable television company that wishes, additionally, to offer telephone service may send advertisements to all television customers to that effect. However, such a method is imprecise and often not cost-effective. Obviously, some of the customers will be more receptive than others, and, during the course of servicing the customer's cable television in this example, a better idea of which services the customer would prefer may be garnered. Perhaps the advertising money would be better spent by focusing on services in which customers would be more interested, such as premium television services or a faster Internet connection.

What is needed is a way to make service technicians, especially those who are not directly employed by the company on whose behalf they are doing work, to feel more connected to the company or product they are servicing. What is also needed is a way for the company to leverage the dispatcher's knowledge of the customers to aid the company in servicing its customers' needs.

### SUMMARY

Embodiments of the disclosed technology are a dispatch management system and method. Customer information is received by a first company and forwarded with dispatch instructions to a second company, such as a dispatch company which handles dispatching a service technician or other support representative to the customer. As a result of a dispatch to the customer, the dispatch company then sends any changes to the dispatch instructions, and other information including customer information, back to the first company. It is then determined which services and/or products (hereinafter Products) are to be advertised to the customer, based on the customer information and other information received from the dispatch company. Advertisements are then sent to the customer based on this determination.

The Products advertised may be determined based on a statistical model of products sold to similar customers. The similar customers may be defined as other customers serviced by the technician servicing the customer and/or having substantially the same dispatch needs as the customer. The services may be monthly services.

The dispatch instructions may be further modified by the first company and/or the dispatch company. Representatives from the first company and the dispatch company may arrange a joint dispatch time with the customer. A technician may be dispatched via a wireless link.

### BRIEF DESCRIPTION OF THE DRAWINGS

FIG. 1 shows a high level diagram of a system of an embodiment of the disclosed technology.

FIG. 2 shows an overview of steps taken by a company in embodiments of the disclosed technology.

FIG. 3 shows a high level diagram of devices which may be used to carry out embodiments of the disclosed technology.

FIG. 4 shows a high level block diagram of a computing device on which embodiments of the disclosed technology may be carried out.

### DETAILED DESCRIPTION

Embodiments of the disclosed technology provide a dispatch management system for receiving customer information at a first company, forwarding the customer information to a dispatch company with dispatch instructions, receiving from the dispatch company changes to the dispatch instructions and, as result of a dispatch to the customer, making a determination regarding Products to be advertised to the customer, based on customer information and other information received from the dispatch company, and sending advertisements to the customer based on the determination regarding Products to be advertised. The company may make the determination on its own or with the help of the dispatch company or a service technician sent to the customer. In the case of the dispatch company or the service technician, such information is forwarded to the company when the results of the dispatch are sent. The company may also use automated means to make the determination, such as by relating the needs of the customer during the dispatch for Products offered by the company, so as to determine what to advertise to the client.

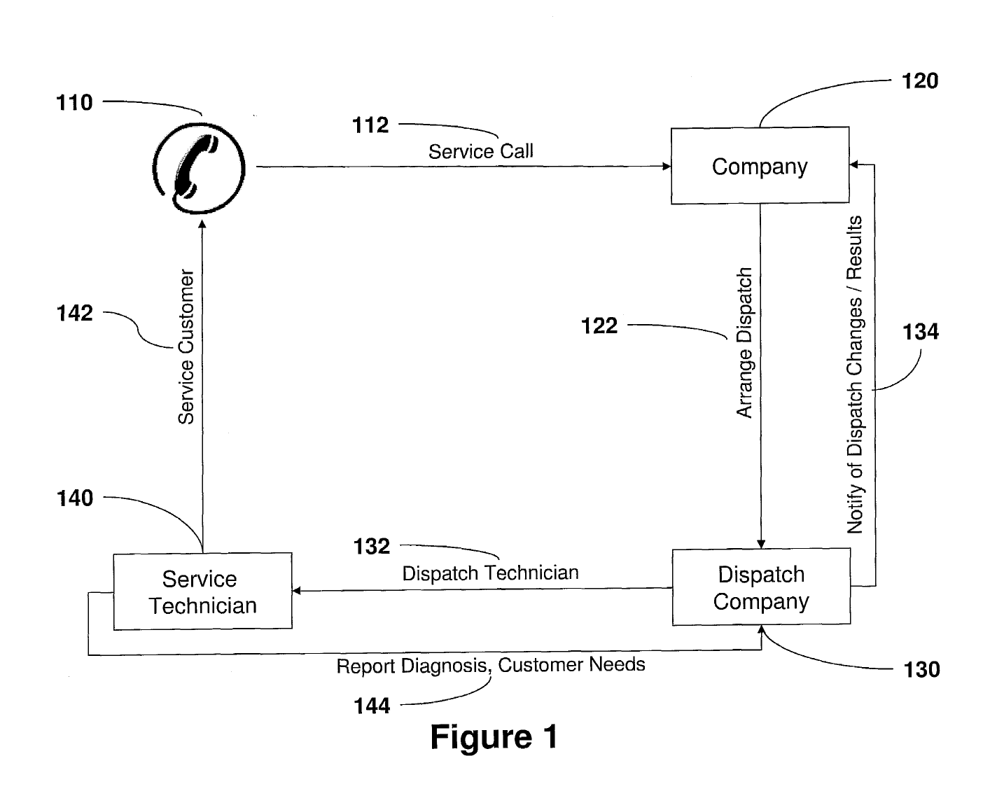

FIG. 1 shows a high level diagram of a system of an embodiment of the disclosed technology. Customer 110 places a service call 112 to a company 120 requesting service for his device or a service provided by the company 120. For example, the customer may seek assistance with a problem he is having with his phone, Internet, television, utilities (electricity, gas), or other service. The customer may also be seeking assistance with an appliance (e.g., washing machine) or other device purchased from the company 120. If the company 120 cannot help the customer over the phone, or in other embodiments without attempting to help over the phone, the company will arrange to dispatch a service technician to handle the problem of the customer 110. Arranging a dispatch requires taking down information about the problem and the date and time when the customer and/or devices associated with the problem are available to be seen by a service technician.

In embodiments of the disclosed technology, when arranging the dispatch 122, a dispatch company 130, meaning, a separate legal entity or person from the company itself, is engaged to provide Products to the customer. The dispatch company 130 may work with the company 120 to determine the best time to service the customer. The dispatch company may make multiple appointments and may include a representative from the company in one of the appointments. As such, the dispatch company 130 notifies the company of dispatch changes 134. In any case, the dispatch company 130 dispatches a service technician in step 132, using a device which is part of the system of the disclosed technology. (The device will be described in greater detail below.) The service technician 140 is generally one skilled in the art or field of the service that the customer 110 needs or requests. The service technician 140 services the customer 110 in step 142. The service technician may be dispatched via a wireless link such as a personal digital assistant, an in-car computer, or a handheld wireless device, or the like. The service technician then uses the device to report the diagnosis and customer needs in step 144, the report going to the dispatch company 130 or directly to the company 120. The dispatch company, in an embodiment of the disclosed technology, sends a separate report of the results of step 144 to the company in step 134. The company then analyzes and uses this information, as well as information from other dispatching companies and service technicians, to determine how best to serve the needs of its customers.

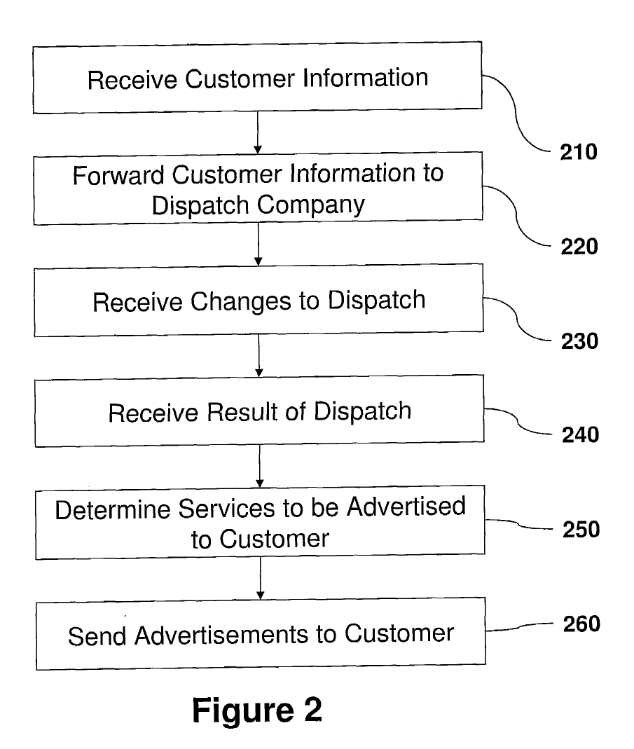

FIG. 2 shows an overview of steps taken by a company in embodiments of the disclosed technology. In step 210, customer information is received. This may be via an incoming phone call, e-mail, or other communication from a customer, i.e., a person, in which a monetary transaction has taken place. The company does not, in embodiments of the disclosed technology, handle the customer needs itself, but rather, sends the customer information, such as a name and address as well as a product or service name and a description of the problem, to a dispatch company in step 220. The dispatch company may further contact the customer or make changes to the scheduled time of the visit to the customer. In step 230, any such changes to the dispatch are reported back to the company for monitoring in order to help determine the needs of the customers, errors in the information which was garnered by the company itself in accessing the customer's needs, and to be able to monitor the dispatch company's progress. Steps 220 and 230 may be part of automated processes and/or the databases of the company and the dispatch company may be linked. After the dispatch company services the customer, in step 240, the results, which may include further information about the problem, the results of the servicing, related products owned by the customer, and/or customer satisfaction data, are sent to the company. Based on this information, the company can better address the needs of the customer and determine which Products should be offered to the customer in step 250. Targeted advertising may then be sent in step 260.

In an example of the above described systems and methods, suppose the customer 110 is a local phone service subscriber with AT&T and the phone wire to the house of the customer has been cut during installation of another underground wire. The customer will call AT&T (from another phone line) and report this service disruption. The company 120, in this case, AT&T, will receive such customer information in step 210. AT&T then contacts a dispatch company 130, such as a contractor or subcontractor to go to the house of the customer in step 220. In step 230, the dispatch company 230 notifies the company of changes, if any, to the dispatch. The company 120 and dispatch company 130 may coordinate their efforts, so as to arrive on scene together. For example, AT&T may desire to send a customer care specialist, while the dispatch company sends a technician with training in wiring during a visit. While the servicing of the customer continues, i.e., the fixing of the wire, the technician may further take note of relevant services, such as if the customer has cable TV or satellite TV; if there is a high speed internet connection if the customer is making calls on a cellular phone or a VoIP phone line, and so forth. Such information, along with the results of each visit or the end of the provision of the service, is received by the company in step 240.

Based on the information acquired during the servicing of the customer (hereinafter Customer Information), the company can now make decisions as to targeted advertising in step 250. For example, it may be determined that the customer with the cut phone wire has cable TV, a cellular phone, and only a dial-up Internet connection. Perhaps it is also determined whether there are children in the house and if new technology products are being used in general, such as fax machines, fast computers, and the like. Based on this information, as well as information garnered from similar customers, such as neighbors (customers within a designated proximity, neighborhood, or town) or those who subscribe to similar services, it can be determined what Products are likely to be purchased by these individuals or businesses in step 250.

In the example of our customer with the cut phone wire, it may be desired to offer high speed Internet access, new TV service, and phone service over the high speed Internet connection in addition to, or as a backup to, the present phone line. In this case, it may be known that statistical models show that customers who subscribe to a certain service are more or less likely to subscribe to another service. For example, customers with high definition televisions and a dial-up modem connection may be extremely likely to sign up for monthly high speed Internet when sent an advertising offer for same. Or, it may be determined that a certain percentage of households serviced by this technician sign up for a voice-over IP telephone line within six months. As such, it may be determined that this particular technician is likely “selling” it to the customers by extolling the advantages of voice-over IP. Rather than stop the technician, the company, in this case AT&T, may decide to advertise monthly voice-over IP specifically to households serviced by this technician, in order to ensure that the customers of the plain old telephone service (POTS) remain AT&T customers when switching to voice over IP. Similarly, those customers who have problems with their POTS service due to poor line quality might be sent advertisements for voice-over IP. Those customers who have problems with their wireless network connections might be advertised a cellular Internet connection, and so on and so forth. Any one of the factors related to the call, such as the nature of the call, services already provided to the customer, statistical modeling or sampling of Products provided in a given area or to customers with similar Products (i.e., overlapping Products), may be taken into account. The results of the data garnered from the service technician i.e., the Customer Information, are used, in embodiments of the disclosed technology, to determine which Products should be advertised to the customer and to do so.

In a further embodiment of the disclosed technology, the information may be sold to third parties for their usage. For example, suppose the customer has a cut phone wire and a service technician determines that the customer does not have cable TV service. In the previous embodiment, this is reported back to the company 120 which may then use this information to advertise services such as Cable TV to the customer. If the company 120 doesn't offer such a service or if desired, then the company 120 may give this information to a third party company and the third party company can make use of the information to send advertisements to the customer. In this manner, the company 120 can profit from this information as well as the third party company and the consumer can receive relevant advertising.

In still a further embodiment of the invention, the company 120 may actually be more than one company using the services of the dispatch company 130 either directly or through a portal or platform, such as a website interface. Still further, the dispatch company 130 may be a plurality of dispatch companies. The portal allows more than one company 120 and more than one dispatch company 130 to receive, send, and share information amongst each other, possibly for a fee paid to the owner of the portal and/or to the suppliers of information. Thus, for example, a phone company and a cable TV company may use a dispatch portal to send service technicians by way of dispatch companies. The dispatch companies report back which customers are ripe for cable TV service and which are ripe for high speed internet. Regardless of whether the service technician was sent on behalf of the cable TV or phone company, either company could use the information to send targeted advertisements for it's service offerings in embodiments of the invention. A commission or fee might be paid to the owner of the portal, to the dispatch company, and/or to the company who currently has the person receiving the dispatch as a customer. Such a system may also be used to combine a dispatch to a customer requiring service from multiple companies or for coordinating a service technician's schedule amongst service calls for multiple companies.

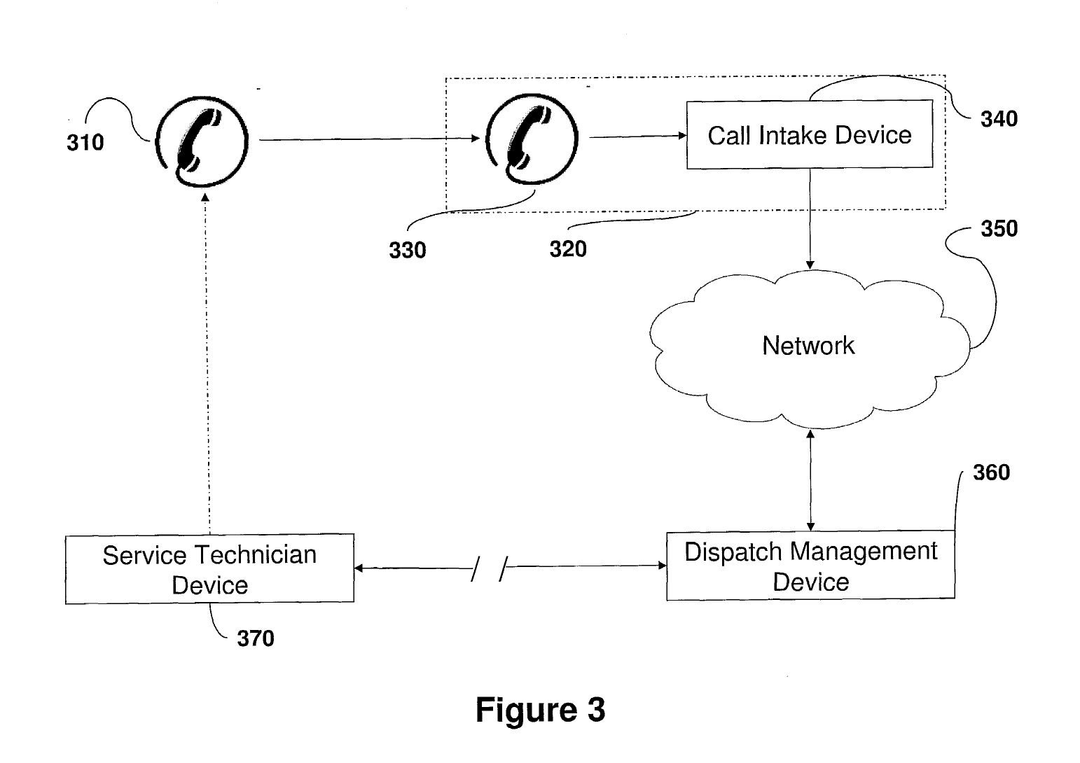

FIG. 3 shows a high level diagram of devices which may be used to carry out embodiments of the disclosed technology. Customer 310 may call a customer service representative 330 working at or acting on behalf of the company 320. The call may be a phone call, an e-mail, or any other means of communication known in the art. The customer service representative 330 may go through call scripts and take in information about the customer and his needs. Such information is entered into a call intake device 340, such as a computing device for processing and scheduling. The relevant data are then shared with a dispatch management device, such as a computing device under the operational control of a contractor or dispatch company which will handle the servicing of the customer. The contact between the call intake device 340 and dispatch management device is over a network 350, such as a local network, a remote network, and/or a packet-switched network such as the Internet. The dispatch management device 360 may also be a personal computer operated by the dispatch company which is used to log into a database provided by the company 320.

The dispatch management device 360 (or call intake device 340) then contacts a suitable service technician via a device 370 operated by the technician, such as a handheld computing device. As the service technician is typically on the road making service calls, the technician's device may be contacted or signaled via a wireless network, such as a cellular network, WiMax, and the like. The service technician device 370 provides to a service technician a map of the area to go to, driving directions, GPS (global positioning system) functionality, description of the service to be performed, prior service history, and the like. The device 370 may also prompt the technician to answer questions such as how long it took to perform the service (may be automatically calculated), what services were performed, a description of the problem and how it was solved, other services subscribed to and relevant data about the customer, and so forth, pertaining to services performed by the service technician, interests of the customer, and other data relating to the service technician's personal contact with the customer on the customer's premises. In this manner, information can be gathered from the customer and reported back to the company. The company can then use the information gleaned by the technician in a determination of what further Products to provide.

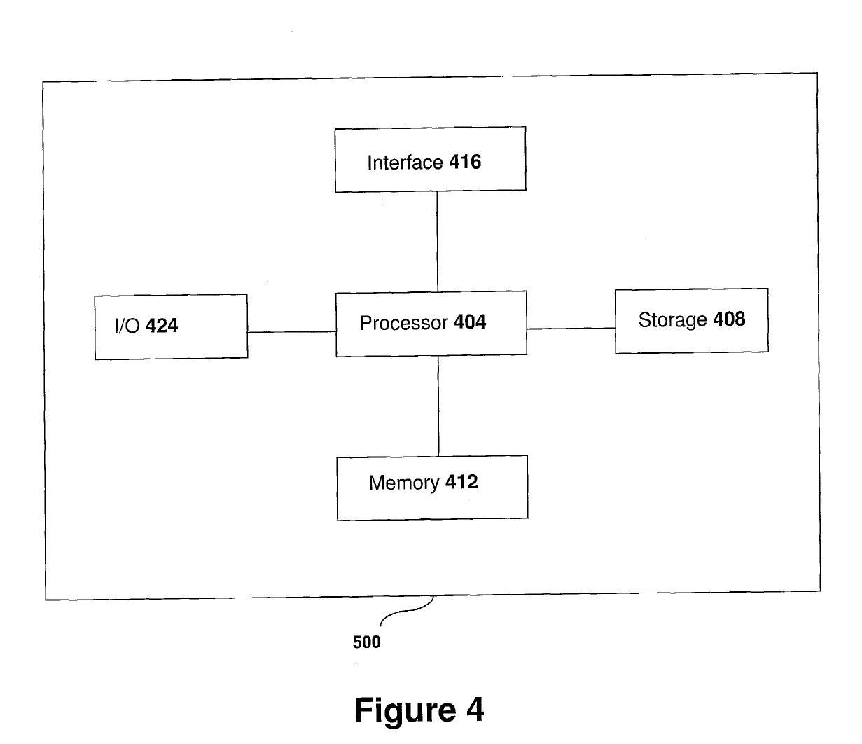

FIG. 4 shows a high level block diagram of a computing device on which embodiments of the disclosed technology may be carried out. Computer 400 contains a processor 404 that controls the overall operation of the computer by executing computer program instructions which define such operation. The computer program instructions may be stored in a storage device 408 (e.g., magnetic disk, database) and loaded into memory 412 when execution of the computer program instructions is desired. Thus, the computer operation will be defined by computer program instructions stored in memory 412 and/or storage 408, and the computer will be controlled by processor 604 executing the computer program instructions. Computer 400 also includes one or a plurality of input network interfaces for communicating with other devices via a network (e.g., the Internet). Computer 400 also includes one or more output network interfaces 416 for communicating with other devices. Computer 400 also includes input/output 624, representing devices which allow for user interaction with the computer 400 (e.g., display, keyboard, mouse, speakers, buttons, etc.). One skilled in the art will recognize that an implementation of an actual computer will contain other components as well, and that FIG. 4 is a high level representation of some of the components of such a computer for illustrative purposes. It should also be understood by one skilled in the art that the method and devices depicted in FIGS. 1 through 3 may be implemented on a device such as is shown in FIG. 4.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A dispatch management method comprising:
receiving customer information at a first company;
forwarding the customer information to a dispatch company with dispatch instructions;
receiving from the dispatch company additional customer information;
determining Products to be advertised to the customer based on the customer information received at the first company and the customer information; and
sending advertisements to the customer related to determined Products.

2. The dispatch management method of claim 1, wherein the determined Products are determined based at least in part on a statistical model of Products sold to similar customers.

3. The dispatch management method of claim 2, wherein the similar customers are other customers serviced by a technician servicing the customer.

4. The dispatch management method of claim 2, wherein the similar customers are other customers currently subscribing to the same services as the customer and having substantially the same dispatch needs as the customer.

5. The dispatch management method of claim 1, wherein the services are monthly services.

6. The dispatch management system of claim 1, wherein said advertisements are sent by a second company.

7. A dispatch management system comprising:
means for receiving customer information at a first company;
means for forwarding the customer information to a dispatch company with dispatch instructions;
means for receiving from the dispatch company additional Customer Information;
means for determining Products to be advertised to the customer based on the customer information received at the first company and the Customer Information; and
means for sending advertisements to the customer related to determined Products.

8. The dispatch management system of claim 7, wherein the determined Products are determined based at least in part on a statistical model of products sold to similar customers.

9. The dispatch management system of claim 8 wherein the similar customers are other customers serviced by the technician servicing the customer.

10 The dispatch management system of claim 8, wherein the similar customers are other customers currently subscribing to the same services as the customer and having substantially the same dispatch need as the customer.

11. The dispatch management system of claim 7, wherein the services are monthly services.

12. The dispatch management system of claim 7, wherein said advertisements are sent by a second company.

13. A computer readable storage medium comprising computer instructions to be executed by a computer processor for carry out the steps of:
receiving customer information at a first company;
forwarding the customer information to a dispatch company with dispatch instructions;
receiving from the dispatch company additional Customer Information;
determining Products to be advertised to the customer based on the customer information received at the first company and the Customer Information; and
sending advertisements to the customer related to determined Products.

14. The computer readable storage medium of claim 13, wherein the determined Products are determined based at least in part on a statistical model of Products sold to similar customers.

15. The computer readable storage medium of claim 14, wherein the similar customers are other customers serviced by a technician servicing the customer.

16. The computer readable storage medium of claim 14, wherein the similar customers are other customers currently subscribing to the same services as the customer and having substantially the same dispatch needs as the customer.

17. The computer readable storage medium of claim 13 wherein the services are monthly services.

18. The computer readable storage medium of claim 13, wherein said advertisements are sent by a second company.
